(19) United States
(12) Patent Application Publication
(10) Pub. No.: US 2007/0181076 A1
(43) Pub. Date: Aug. 9, 2007

(54) Magnetically Attachable Bedding for an Animal House

(76) Inventor: Dan L. Dietz, Houston, TX (US)

Correspondence Address: TUMEY, L.L.P., P.O. BOX 22188, HOUSTON, TX, 77227-2188, US

(21) Appl. No.: 11/563,650

(22) Filed: Nov. 27, 2006

Related U.S. Application Data
(63) Continuation-in-part of application No. 11/459,868, filed on Jul. 25, 2006.
Application No. 11/459,868 is a continuation-in-part of application No. 11/456,817, filed on Jul. 11, 2006.
Application No. 11/456,817 is a continuation-in-part of application No. 11/455,489, filed on Jun. 19, 2006.
Application No. 11/455,489 is a continuation-in-part of application No. 11/438,040, filed on May 19, 2006.
Application No. 11/438,040 is a continuation-in-part of application No. 11/287,716, filed on Nov. 28, 2005, now Pat. No. 7,234,415.
Application No. 11/287,716 is a continuation-in-part of application No. 11/121,797, filed on May 4, 2005.

(51) Int. Cl. A01K 1/03

(52) U.S. Cl. 119/482

(57) ABSTRACT

An animal housing and a method for providing bedding thereto are disclosed. In an embodiment, the animal housing comprises a top and a plurality of sides. The plurality of sides provide support to the top. The animal housing further includes a bedding. The bedding includes a cushion, a pillow, a magnet, and a magnetically attractive material, wherein magnetism of the magnet attracting the magnet to the magnetically attractive material secures the pillow to the cushion.

### CROSS-REFERENCE TO RELATED APPLICATIONS

This application is a continuation-in-part application of U.S. application Ser. No. 11/459,868 filed on Jul. 25, 2006, which is a continuation-in-part application of U.S. application Ser. No. 11/456,817 filed on Jul. 11, 2006, which is a continuation-in-part application of U.S. application Ser. No. 11/455,489 filed on Jun. 19, 2006, which is a continuation-in-part application of U.S. application Ser. No. 11/438,040 filed on May 19, 2006, which is a continuation-in-part application of U.S. application Ser. No. 11/287,716 filed on Nov. 28, 2005, which is a continuation-in-part application of U.S. application Ser. No. 11/121,797 filed on May 4, 2005, which are each herein incorporated by reference in their entirety.

### STATEMENT REGARDING FEDERALLY SPONSORED RESEARCH OR DEVELOPMENT

Not applicable.

### BACKGROUND OF THE INVENTION

1. Field of the Invention

This invention relates to a magnetically attachable bedding and more specifically to a magnetically attachable pillow for an animal housing.

2. Background of the Invention

Pillows are often placed on bedding. Drawbacks to the typical pillows include unwanted movement of the pillow in relation to the bedding. For instance, pillows may be used in bedding for animals. Animals are not typically stationary in the bedding, and the movement of such animals may facilitate movement of the pillow. Such movement of the pillow may be unwanted by the animal owner. In some instances, such pillow and bedding are disposed in a housing for an animal such as a cage. In such instances, drawbacks to such unwanted movement of the pillow include blocking of entry into the cage by the pillow.

Therefore, there is a need for an improved method for preventing unwanted movement of a pillow. Further needs include improved bedding.

### BRIEF SUMMARY OF SOME OF THE PREFERRED EMBODIMENTS

These and other needs in the art are addressed by an animal housing. The animal housing includes a top and a plurality of sides. The plurality of sides provide support to the top. The animal housing further includes a bedding. The bedding includes a cushion, a pillow, a magnet, and a magnetically attractive material. Magnetism of the magnet attracting the magnet to the magnetically attractive material secures the pillow to the cushion.

In another embodiment, these and other needs in the art are addressed by a method for providing bedding for an animal housing. The method includes providing an animal housing. The animal housing includes a top and a plurality of sides The plurality of sides provides support to the top. In addition, the method includes providing a cushion and a pillow. The method further includes securing the pillow to the cushion by magnetic attraction to provide the bedding. The method also includes disposing the bedding on the top or inside the animal housing.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an animal housing;

FIG. 2 illustrates an embodiment of FIG. 1 with the top at an open position;

FIG. 3 illustrates an animal housing with a ramp;

FIG. 4 illustrates an animal housing with a cushion;

FIG. 5 illustrates a cushion;

FIG. 6 illustrates an embodiment of a pillow magnetically secured to the cushion;

FIG. 7 illustrates an embodiment of a pillow magnetically secured to the cushion;

FIG. 8 illustrates another embodiment of a pillow magnetically secured to the cushion;

FIG. 9 illustrates a ramp;

FIG. 10 illustrates a cross-sectional side view of the ramp of FIG. 9;

FIG. 11 illustrates a mat;

FIG. 12 illustrates a cross-sectional side view of the mat of FIG. 11;

FIG. 13 illustrates a cross-sectional view of a bedding;

FIG. 14 illustrates a back side of the animal housing with a rack means;

FIG. 15 illustrates a detachable grate;

FIG. 16 illustrates a cross-sectional view of a guide;

FIG. 17 illustrates a front view of an animal housing showing a front and top side and having a cage and an outer covering;

FIG. 18(a) illustrates an embodiment of a side of the outer covering;

FIG. 18(b) illustrates an embodiment of a side of the outer covering;

FIG. 19 illustrates an embodiment showing a cage and an outer covering with the top side of the outer covering removed;

FIG. 20 illustrates an animal housing comprising a cage;

FIG. 21 illustrates an embodiment of the animal housing of FIG. 17 with a door in an open position;

FIG. 22 illustrates an embodiment of the animal housing having a base and a grate;

FIG. 23 illustrates a top view of an embodiment of a base;

FIG. 24 illustrates a top view of an alternate configuration of an embodiment of a base;

FIG. 25 illustrates a cross sectional side view of the animal housing having a base and a cage;

FIG. 26 illustrates a side having a grate; and

FIG. 27 illustrates securing a pillow to a wall.

### DETAILED DESCRIPTION OF THE PREFERRED EMBODIMENTS

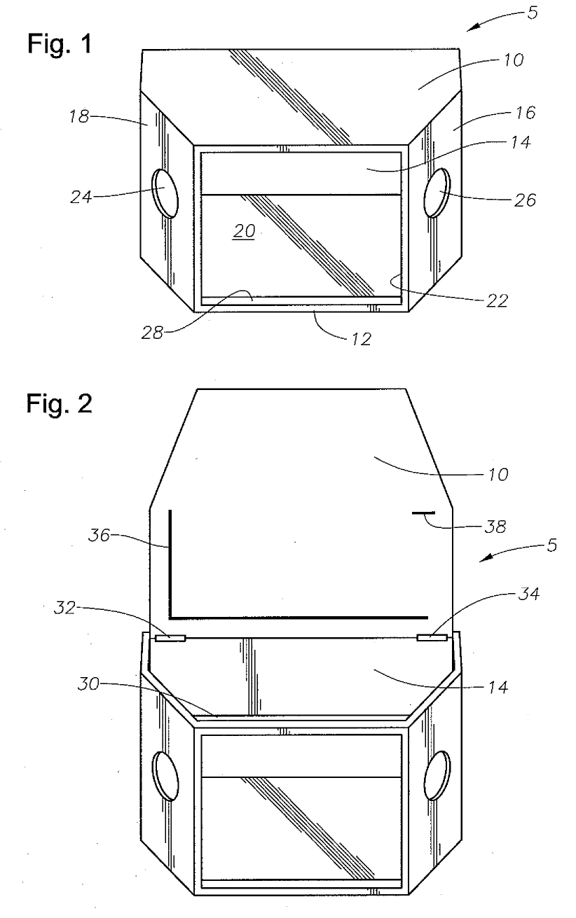

FIG. 1 illustrates an embodiment of animal housing 5 having a top 10, a front side 12, a back side 14, and side walls 16, 18. Animal housing 5 may also contain a floor 20. Front side 12 has an opening 22. Opening 22 may be of any desirable size. In an embodiment, opening 22 is of a size suitable for a desired animal to pass therethrough. Animal housing 5 also has openings 24, 26 disposed in the side walls 16, 18. Without being limited by theory, openings 24, 26 may improve ventilation in animal housing 5. Each side wall may have one or more than one opening. In alternative embodiments (not illustrated), at least one side wall may not have an opening. It is to be understood that openings in side walls may be of any desired shape and size. Front side 12 also has a lip 28. In some embodiments, a lip section (not illustrated) may also be attached to top 10. Without limitation, such a lip section may serve as a restraining means to stabilize and keep a bedding stationary when an animal is resting thereupon. In embodiments, side walls 16, 18 provide physical support to top 10. It is to be understood that animal housing 5 is not limited to side walls 16, 18 but may instead include any number of sides (e.g., a plurality of side walls) depending, for instance, on the desired configuration. An animal housing is disclosed in U.S. patent application Ser. No. 11/459,868, which is incorporated by reference herein in its entirety.

It is to be understood that side walls 16, 18 may have one or more than one opening, respectively, and that side walls 16, 18 are shown in FIG. 1 with each side wall 16, 18 having one opening each (openings 24, 26) for illustration purposes only. It is also to be understood that back side 14 may have no such openings or one or more such openings. In an alternative embodiment, one or more of the sides may have no such openings. Openings in side walls 16, 18 and back side 14 may have any shape, configuration, and size suitable for allowing ventilation and visibility into and out of animal housing 5. For instance, such openings may have the shape of characters such as animals, cartoon figures, toys, lettering, numbering, symbols, and the like. Without limitation, examples of animal shapes include dogs, cats, and the like. In addition, without limitation, examples of cartoon figures include MICKEY MOUSE (which is a mark owned by Disney Enterprises, Inc.), SUPERMAN (which is a mark owned by DC Comics Warner Communications Inc.), and the like. Examples of toys include, without limitation, trucks, cars, airplanes, and the like. The character shape openings may be applied to the sides by any suitable process such as by a cutting apparatus, press, or the like.

Animal housing 5 may be composed of any material suitable for the uses of animal housing 5. For instance, animal housing 5 may include wood, mesh, wire, plastic, metal, and the like. In such an embodiment, back side 14 and/or side walls 16 and 18 may comprise wire, mesh, netting, weaving, and the like, preferably wire or mesh, and more preferably wire or wire-like material. Moreover, back side 14 and/or side walls 16 and 18 may be composed of any porous material suitable for use as a side in an animal cage (e.g., porous metal or plastic siding). In an embodiment, back side 14 and/or side walls 16 and 18 are composed of a plastic, wood, metal, or the like wire or wire-like material. One or more of side walls 16 and 18 (preferably both side walls 16, 18) may be composed of such materials. In an embodiment (not illustrated), an outer covering may be disposed on the outside and/or inside surface of one or more of any side (e.g., front side 12, back side 14, side walls 16 and 18, top 10, floor 20), preferably an outer covering is disposed on the outside surface. In some embodiments, an outer covering is disposed on the outside surface of side walls 16 and 18, back side 14 and/or top 10. The outer covering may cover any desired portion of a side. In addition, the outer covering may comprise any suitable covering for use with animals. For instance, the outer covering may be composed of natural or synthetic woods, veneers, vinyl, a weaving, plastic, ceramic, and the like. The weaving may include wicker, vinyl, and any other weavable material suitable for use with animal housing 5. In an embodiment, top 10 and/or front side 12 may also be composed of such plurality of openings and/or alternatively may also include such an outer covering. In alternative embodiments, at least one side and/or wall of animal housing 5 comprises a substantially solid material.

FIG. 2 shows animal housing 5 with top 10 extended in an upward position. As shown, a bar 30 extends across front side 12. In an embodiment, bar 30 may provide support to top 10. Hinges 32 and 34 attach top 10 to back side 14 and allow top 10 to open and close as desired. Attached to the inside surface of top 10 side is a rack member 36 for holding a ramp member when such ramp member is not in use. Rack member 36 may have any suitable shape (e.g., an L-shape) that fits with the shape of a rectangular ramp member. In an embodiment, rack member 36 is a groove with a generally u-shape in which the ramp member is placed. When the ramp member is placed in rack member 36, a latch 38 secures the ramp in rack member 36.

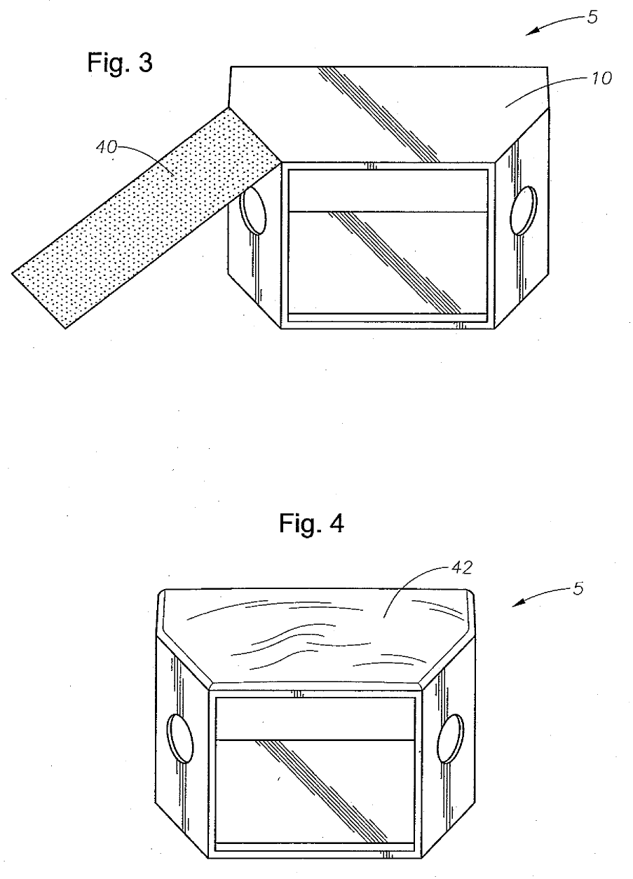

FIG. 3 shows a configuration of animal housing 5 with a detachable ramp 40 engaged at one side. In this configuration, an animal may climb to top 10 of animal housing 5. Depending on the height of animal housing 5, the length of ramp 40 may vary such that the inclination angle formed by the engagement of ramp 40 to animal housing 5 is not too steep for the animal to safely climb.

FIG. 4 shows animal housing 5 with a bedding 42 positioned on top 10. Bedding 42 may be composed of any suitable materials on which an animal may be disposed such as a cushion, mattress, pillow and the like. FIG. 13 shows a cross-section of an embodiment of bedding 42.

Bedding 42 may have any desirable shape suitable for use with animal housing 5. Bedding 42 may comprise any soft material suitable for an animal to be disposed thereupon. Without limitation, examples of such materials of which bedding 42 may be composed include wool, hair, feathers, polyester staple fiber, foam, paper, or combinations thereof. The foam may comprise any suitable foam for use with an animal. In an embodiment, the foam includes memory foam. It is to be understood that memory foam refers to visco-elastic polyurethane foam.

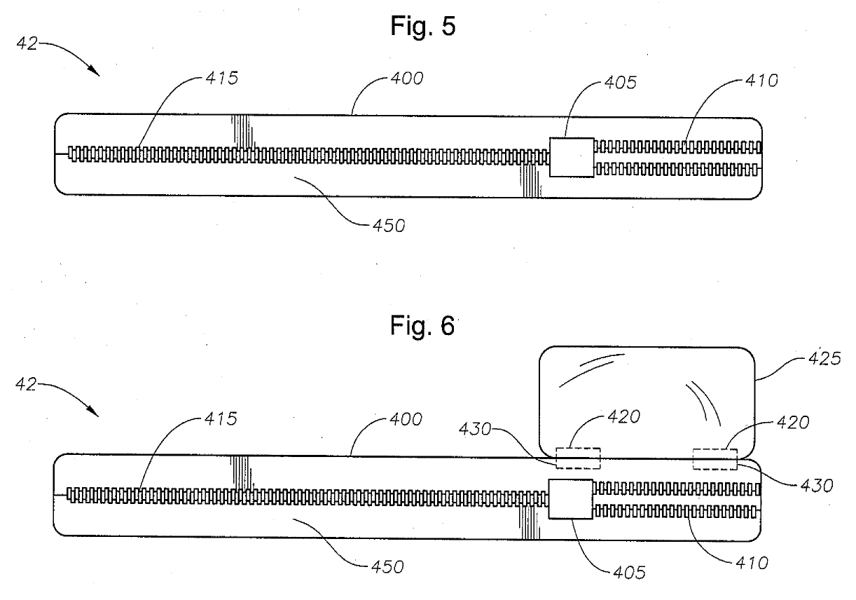

FIG. 5 illustrates an embodiment of bedding 42 having a cushion 450 disposed within a cover 400. Cover 400 may be composed of any suitable material for use with a cushion 450. Without limitation, examples of suitable materials for cover 400 include cloth, linen, plastic, or combination thereof Cover 400 may be openable and closeable and includes a closing means for closing cover 400. The closing means may include any closing means suitable for closing an opening in cover 400. Without limitation, examples of suitable closing means include buttons, zippers, VELCRO, and the like. VELCRO is a hook and loop type fastener that is commercially available from Velcro Industries N.V. As shown in FIG. 5, cover 400 includes the closing means comprising a zipper 405. Any type of zipper suitable for closing an opening in cover 400 may be used. It is to be understood that FIG. 5 illustrates cover 400 with an open portion 410 and a closed portion 415. In such an embodiment, zipper 405 may be moved to close open portion 410. It is to be further understood that zipper 405 may be moved to open or close more of cover 400 than shown in FIG. 5. In some embodiments (not illustrated), cover 400 has more one or more zippers 405 and/or one or more other closing means (e.g., VELCRO). In addition, closing means (e.g., zipper 405) is not limited to extending along the length of cushion 450, but instead may cover a portion of the length of cushion 450. In some embodiments (not illustrated), one or more closing means may extend at an angle or angles to a horizontal plane intersecting cushion 450. In an embodiment, cover 400 may be sufficiently openable to provide an open portion 410 that allows access to the interior of cover 400. For instance, zipper 405 may be moved to provide an open portion 410 of cover 400 that allows a user access to the interior of cover 400.

FIG. 6 illustrates an embodiment in which bedding 42 includes a pillow 425 secured to cushion 450. As illustrated in FIG. 6, pillow 425 has magnets 420. In an embodiment, magnets 420 are permanent magnets. In other embodiments (not illustrated), pillow 420 has one magnet 420 or more than two magnets 420. In an embodiment as shown in FIG. 6, magnetically attractive material 430 is disposed within cover 400 and secured to magnets 420 by magnetic force. Permanent magnets 420 of any strength may be selected. In some embodiments, permanent magnets 420 are selected to sufficiently secure pillow 425 to cushion 450. Magnetically attractive material 430 may include any material that attracts a magnetic force. Without limitation, examples of suitable magnetically attractive material includes a magnet, iron, steel, and the like. Magnets 420 may be secured to pillow 425 by any suitable means. For instance, such means may include gluing magnets 420 to pillow 425, sewing magnets 420 to pillow 425, and the like. In some embodiments, magnets 420 may be embedded in a pillow cover or secured to a pillow cover in which pillow 425 is disposed.

In an embodiment as shown in FIG. 6, pillow 425 is secured to cushion 450. In such an embodiment, to accomplish securing pillow 425 to cushion 450, zipper 405 is moved to provide an open portion 410 of sufficient size to allow access to the interior of cover 400. Magnetically attractive material 430 may then be placed into the interior of cover 400. Magnets 420 attract magnetically attractive material 430 and secure pillow 425 to cushion 450. Without being limited by theory, pillow 425 may be secured at any desired location on cushion 450. In an alternative embodiment, magnetically attractive material 430 is attached to the interior of cover 400 by any suitable method such as by glue, sewn to cover 400, and the like. In such an alternative embodiment, at least a portion of the magnetically attractive materials 430 are secured to cover 400 a similar distance apart as magnets 420. In addition, in such an alternative embodiment, pillow 425 may be placed on cushion 450 and secured to cushion 450 when magnets 420 attract magnetically attractive material 430.

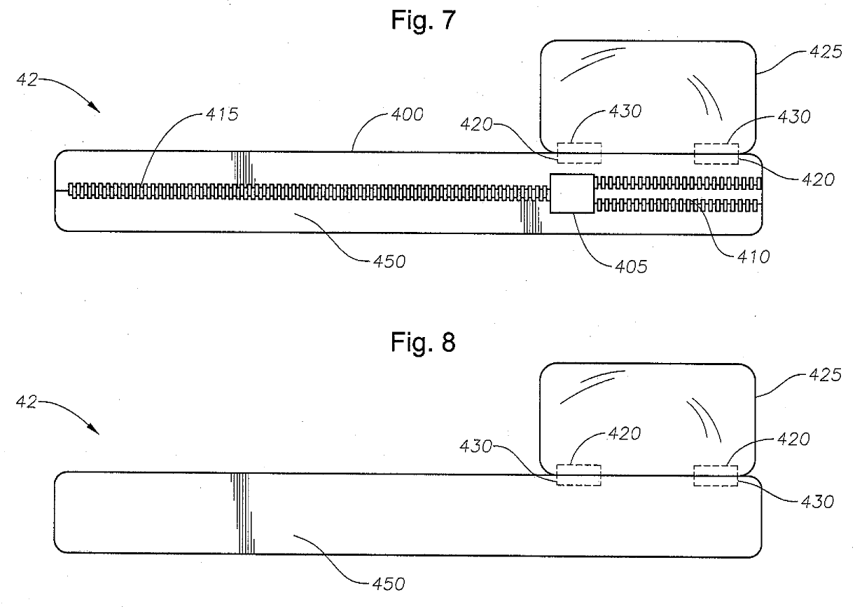

FIG. 7 illustrates an embodiment in which bedding 42 includes a magnetically attractive material 430 secured to pillow 425. Magnetically attractive material 430 may be secured to pillow 425 by any suitable means. For instance, such means may include gluing magnetically attractive material 430 to pillow 425, sewing magnetically attractive material 430 to pillow 425, and the like. In some embodiments, magnetically attractive material 430 may be embedded in a pillow cover or secured to a pillow cover in which pillow 425 is disposed.

In an embodiment as shown in FIG. 7, pillow 425 is secured to cushion 450. In such an embodiment, zipper 405 is moved to provide an open portion 410 of sufficient size to allow access to the interior of cover 400. Magnets 420 may then be placed into the interior of cover 400. Magnets 420 attract magnetically attractive material 430 and secure pillow 425 to cushion 450. In an alternative embodiment, magnets 420 are attached to the interior of cover 400 by any suitable method such as by glue, sewn to cover 400, and the like. In such an alternative embodiment, at least a portion of magnets 420 are secured to cover 400 a similar distance apart as magnetically attractive material 430. In addition, in such an alternative embodiment, pillow 425 may be placed on cushion 450 and secured to cushion 450 when magnets 420 attract magnetically attractive material 430.

FIG. 8 illustrates an embodiment of bedding 42 in which cushion 450 is not disposed within cover 410. As illustrated in FIG. 8, magnetically attractive material 430 are secured to cushion 450. Magnetically attractive material 430 may be secured to cushion 450 by any suitable method. For instance, magnetically attractive material 430 may be secured to cushion 450 by glue, sewn to cushion 450, and the like. Magnets 420 are secured to pillow 425.

As shown in FIG. 8, pillow 425 is secured to cushion 450. In such an embodiment, magnets 420 attract magnetically attractive material 430 and secure pillow 425 to cushion 450. In an embodiment (not illustrated), pillow 425 may be disposed within a cover (e.g., a pillow cover). In such an embodiment, pillow 425 may be placed over the area of cushion 450 in which magnetically attractive material 430 is disposed. Further, magnets 420 are placed in the cover (e.g., pillow cover) and magnetically attracted to magnetically attractive material 430, thereby securing pillow 425 to cushion 450. In an alternative embodiment (not illustrated), magnets 420 are secured to cushion 450 and magnetically attractive material 430 is attached to pillow 425. In another alternative embodiment (not illustrated), pillow 425 is disposed within a cover (e.g., pillow cover). In such another alternative embodiment, magnetically attractive material 430 is placed within the cover (e.g., pillow cover) and magnets 420 are magnetically attracted thereto, thereby securing pillow 425 to cushion 450.

It is to be understood that embodiments of bedding 42 having cushion 450 and pillow 425 are not limited to disposition in animal housing 5 and/or on top 10 but instead may be used remote from animal housing 5. For instance, such bedding 42 may be used with humans or other animals. As an example, bedding 42 may be used with a couch, a human bed, and the like.

In an alternative embodiment (not illustrated), at least one magnet is secured to a pillow. In addition, magnetically attractive material may be attached to an object such as a wall, furniture, and the like. The magnetically attractive material may be attached to the wall by glue, screws, or any other suitable method. In some embodiments, the magnetically attractive material may be embedded in the object (e.g., embedded in the wall). The magnetically attractive material is secured to the object a desired distance above top 10. Animal housing 5 may be disposed against or near the object. The pillow may be disposed on top 10 of animal housing 5 with the at least one magnet in contact with the magnetically attractive material to secure the pillow to the wall. For instance, as shown in FIG. 27, magnetically attractive material 305 are secured to wall 300. Animal housing 5 is disposed against or near wall 300. A pillow (not illustrated) may then be disposed on top 10. At least one magnet in the pillow is secured to at least one of the magnetically attractive material 305 to secure the pillow to wall 300. It is to be understood that in alternative embodiments the pillow may include magnetically attractive material and magnets may be secured to the object.

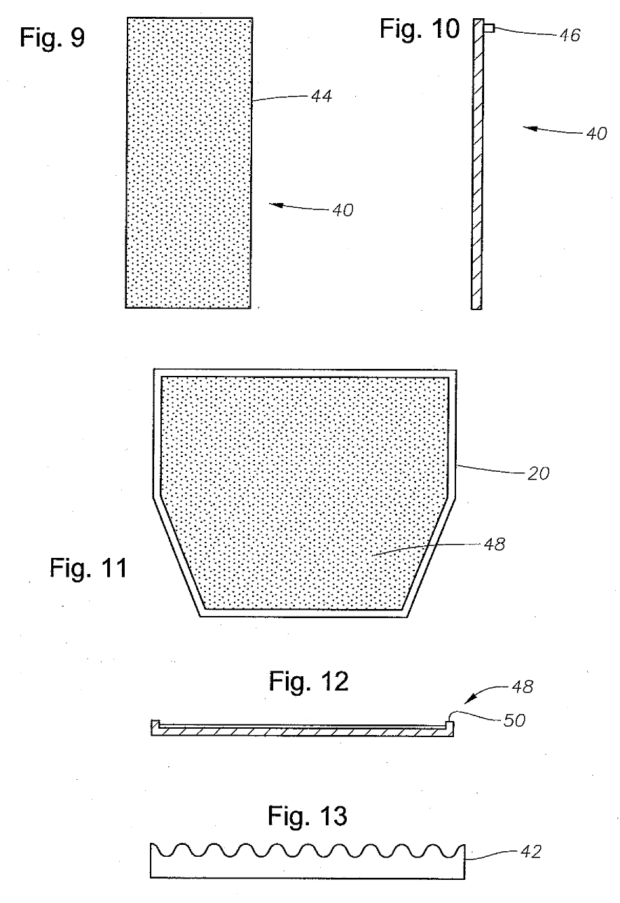

FIG. 9 shows a front view of ramp member 40. A fiber-type material 44 (e.g., cloth or carpet material) is attached thereto. In an embodiment, fiber-type material 44 increases the friction of ramp member 40 such that an animal may have improved traction as the animal climbs ramp member 40 to top 10. FIG. 10 shows a side cross-sectional view of ramp member 40. Ramp member 40 contains a lip 46 that engages an edge of top 10 securing ramp member 40 to animal housing 5.

FIG. 11 shows a view of a floor 20 of animal housing 5 on which mat material 48 is disposed. Mat material 48 may be an elastic or rubber type of material or other type of water-proof material. Mat material 48 extends up the side walls of animal housing 5 thereby covering substantially all or a portion of floor 20. Without being limited by theory, mat material 48 provides a way to easily clean animal housing 5. In an embodiment, mat material 48 is removeable from animal housing 5.

FIG. 12 shows the cross-section of mat material 48. Edge 50 of mat material 48 has a lip shape that prevents substances from escaping the mat material 48 surface. Mat material 48 may also have a ridged surface similar to FIG. 13 for channeling liquid. In alternative embodiments, animal housing 5 may comprise mat material 48 and/or a thermoelectric cushion (not illustrated). In an embodiment, the thermoelectric cushion is disposed on mat material 48. In some embodiments, animal housing 5 comprises more than one thermoelectric cushion. The thermoelectric cushion may comprise any desired shape and size. For instance, the thermoelectric cushion may be suitable as an animal bed. The thermoelectric cushion may provide heating and/or cooling functions. Without limitation, a commercial example of a thermoelectric cushion is the THERMOELECTRIC COOLER & PET BED, which is a thermoelectric bed commercially available from Laurina Company Limited. In alternative embodiments, a thermoelectric cushion may be disposed on top 10.

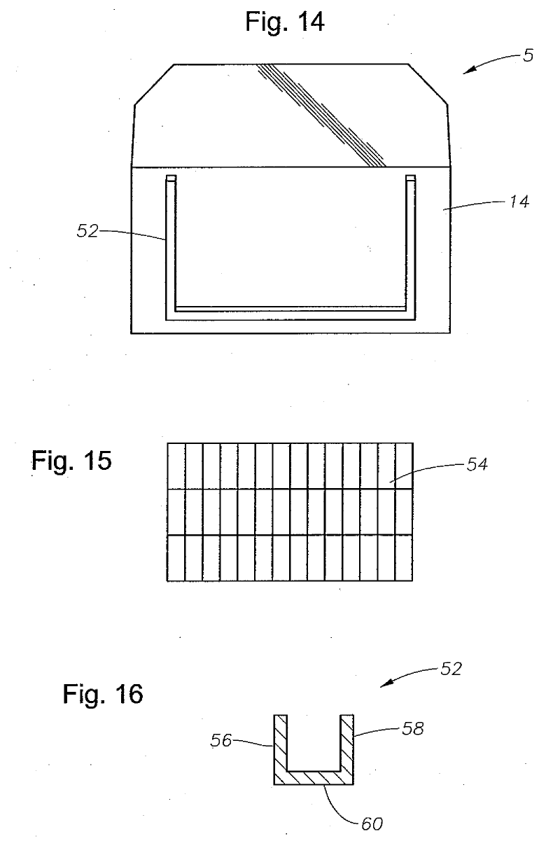

FIG. 14 shows back side 14 of animal housing 5. Attached to back side 14 is a storage rack 52 similar to rack member 36. Without limitation, storage rack 52 may hold grate 54, which is shown in FIG. 15. Storage rack 52 has a general shape that matches the shape of grate 54. FIG. 16 shows a cross-section of storage rack 52. Storage rack 52 has two sides 56 and 58 and a base 60. The two sides 56, 58 are perpendicularly attached to the base 60. One side is also attached to the back side 14. When grate 54 is not in use, grate 54 may be slid into storage rack 52. Grate 54 may be disposed in front opening 22. Grate 54 may have different designs and may also be composed of screen material. In other embodiments, any suitable material (e.g., plastic) may be disposed in front opening 22 in place of or in addition to grate 54. It is to be understood that a grate refers to a framework of parallel or latticed bars that may be suitable for blocking an opening.

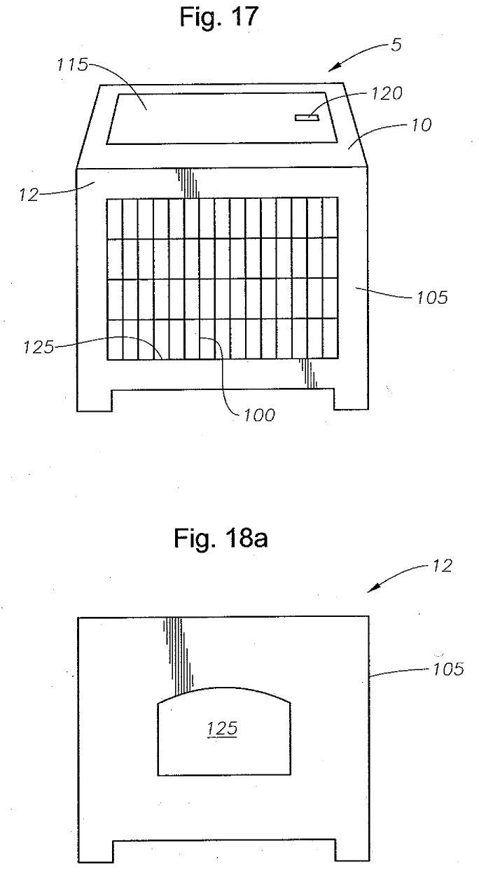

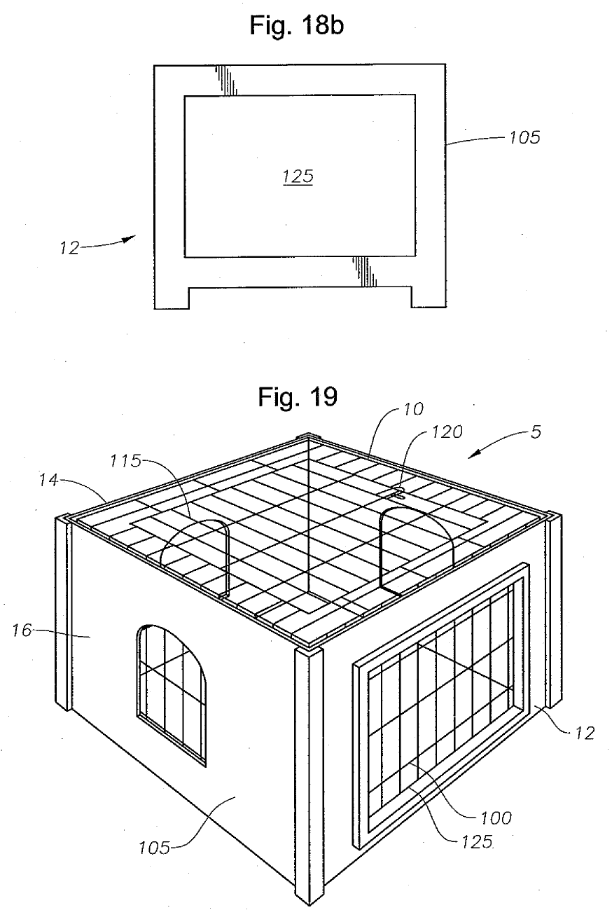

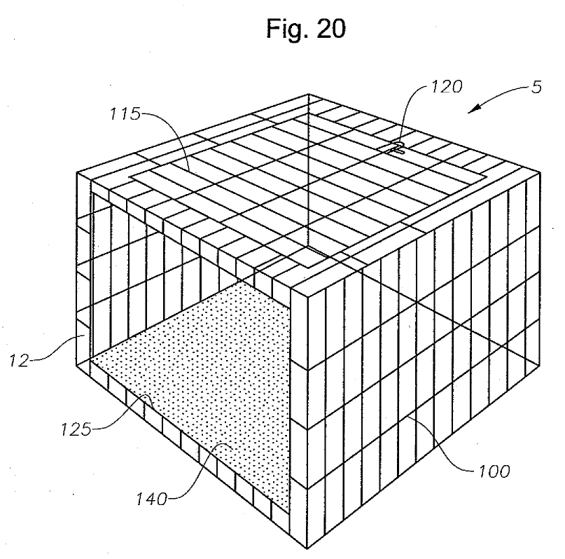

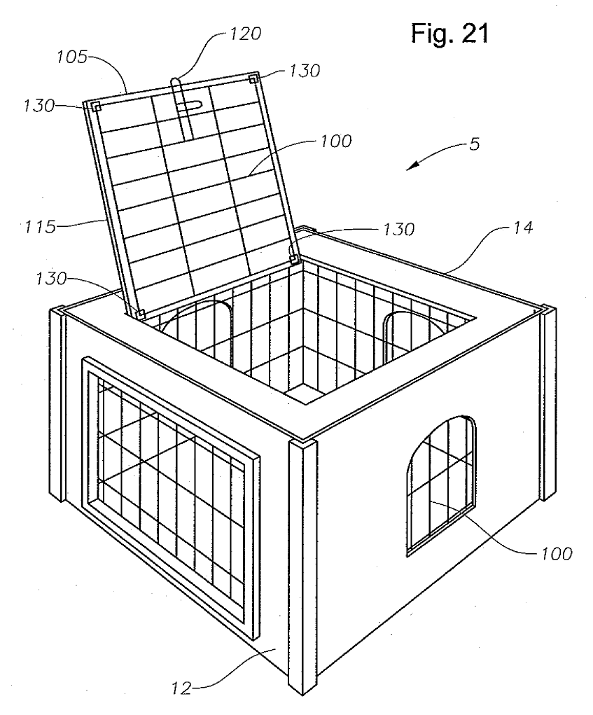

In an embodiment, animal housing 5 comprises a cage and/or an outer covering on top side 10, back side 14, front side 12, and sides 16, 18 of the cage (e.g., on all sides of the cage). In an alternative embodiment, animal housing 5 also comprises an outer covering on bottom side (e.g., floor 20). FIG. 17 illustrates a front view of such an embodiment showing front side 12 and top 10. In such an embodiment, animal housing 5 comprises a cage 100 and an outer covering 105. Cage 100 may comprise any suitable material for containing an animal. For instance, cage 100 may comprise metal, wood, plastic, ceramic, and the like. The sides of cage 100 may be attached by any suitable means. In an embodiment, top side 10 has a door 115 that is movably openable and closable. Door 115 comprises a latching mechanism 120 by which door 115 may be secured to top side 10 and substantially prevented from movement. Latching mechanism 120 may comprise any suitable mechanism for opening and closing door 115 and also suitable for securing door 115 against movement relative to top side 10. It is to be understood that FIG. 17 shows door 115 in a closed position. FIG. 21 illustrates an embodiment in which door 115 is in an open position. As shown in FIG. 17, outer covering 105 on front side 12 has opening 125 by which cage 100 is exposed therethrough. In an embodiment, at least one side of outer covering 105 has an opening; alternatively front side 12, sides 16, 18, and back side 14 of outer covering 105 has such openings; and alternatively all sides of outer covering 105 have an opening. FIGS. 18(a) and 18(b) show embodiments of sides of outer covering 105 having different opening configurations. For instance, FIG. 18(a) illustrates outer covering 105 having opening 125 therethrough. Outer covering 105 having such opening 125 may be suitable as side 16, side 18, and/or back side 14. It is to be understood that outer covering 105 may have more than one opening 125. Opening 125 may have any desirable shape and size. FIG. 18(b) illustrates an embodiment of front side 12 having outer covering 105 with opening 125. In such an embodiment, opening 125 may be of sufficient size to allow a desirable animal to pass therethrough. Further referring to FIG. 17, in an alternative embodiment, front side 12 of cage 100 may be movably attached to side 16 or 18 of cage 100. In such an embodiment, front side 12 of cage 100 may be sufficiently movable to allow a desirable animal to pass through opening 125 in front side 12. In such an alternative embodiment, front side 12 of cage 100 may also be sufficiently closable to prevent the desirable animal from passing through opening 125 in front side 12. In an alternative embodiment (not illustrated), another side is openable to allow a desirable animal to pass through an opening 125 therein into multiple functional animal furniture piece 5. In such an alternative embodiment, top side 10 may or may not be openable.

It is to be understood that outer covering 105 may be secured to cage 100 or not secured to cage 100. In an embodiment in which outer covering 105 is secured to cage 100, outer covering 105 may be secured by any suitable method. For instance, outer covering 105 may be secured to cage 100. by one or more grooves in outer covering 105. As an example, portions of cage 100 may be suitably secured into a groove disposed in outer covering 105.

FIG. 19 illustrates an embodiment of FIG. 17 with outer covering 105 of top 10 removed to expose top 10 of cage 100 for illustration purposes. As shown, door 115 has latching mechanism 120.

The sides of outer covering 105 may be attached by any suitable method. For instance, the sides may be connected by magnets, glue, hooks, and the like. In an embodiment, the sides are connected by magnets. Each side of outer covering 105 may have any number of magnets suitable to sufficiently secure one such side to another such side (e.g., by magnetic attraction to another side). The magnets may be secured to the exterior of the outer covering 105 (e.g., by glue) and/or may be embedded in the outer covering 105. It is to be understood that each side of outer covering 105 may be separated from another side by applying sufficient force to overcome the force of the magnet. Thereby, one or more sides of outer covering 105 may be removed to expose cage 100. In an alternative embodiment, magnets disposed on the outer covering 105 may also be used to secure outer covering 105 to cage 100. For instance, FIG. 21 illustrates an embodiment in which magnets 130 on outer covering 105 of door 115 secure such outer covering 105 of door 115 to the cage portion 100 of door 115.

It is to be understood that sides 12, 14, 16, and 18 are for illustration and explanatory purposes and embodiments described for one of such particular sides may be suitable for one or more other of such sides.

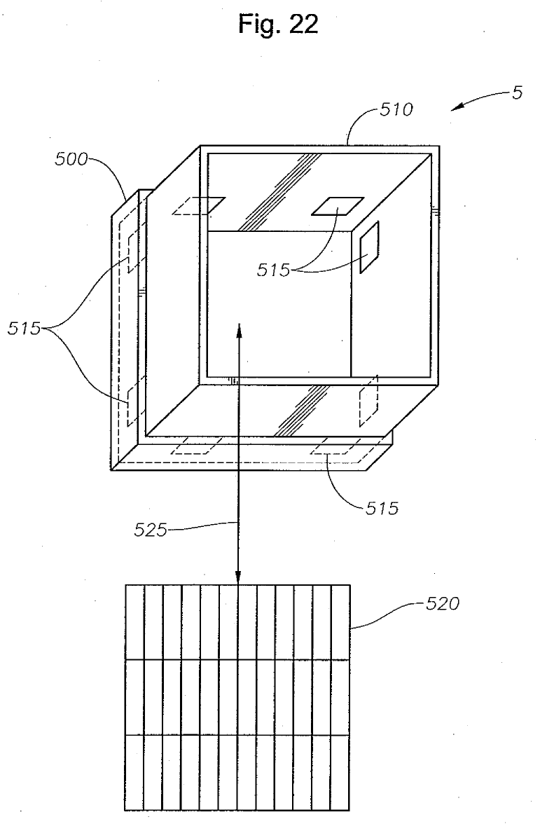

FIG. 22 illustrates an embodiment in which animal housing 5 comprises a base 500 and an outer covering 510. Animal housing 5 may optionally comprise a cage 100 (not illustrated). Base 500 comprises any material suitable for use with an animal cage. Without limitation, examples of suitable materials include plastic, ceramic, stainless steel, and the like. Preferable materials include plastic. Base 500 preferably comprises a similar configuration to that of outer covering 510. In addition, base 500 has a width and length suitable for outer covering 510 to be disposed inside of base 500. Preferably, outer covering 510 is disposed within sufficient proximity to base 500 for magnets 515 disposed within base 500 and/or outer covering 510 to provide a desirable stability (e.g., lateral and vertical stability) to outer covering 510. Base 500 may comprise any height suitable for providing strength and integrity to outer covering 510. In an embodiment, the height of base 500 is less than the height of outer covering 510.

As shown in FIG. 22, outer covering 510 comprises magnets 515. In alternative embodiments (not illustrated), base 500 and/or outer covering 510 comprise magnets 515. Magnets 515 may be attached to base 500 and/or outer covering 510 and/or may be embedded in base 500 and/or outer covering 510. In such an embodiment, animal housing S may comprise any desired number and type of magnets. In an embodiment (not illustrated), magnets 515 are disposed in base 500. In such an embodiment, magnetically attractive material may be attached to outer covering 510 in sufficient locations that when outer covering 510 is placed in base 500, the magnets 515 secure outer covering 510 to base 500. The magnetically attractive material may be attached to outer covering 510 by any suitable means such as by glue. For instance, the magnetically attractive material may be disposed in locations on outer covering 510 that correspond to locations on base 500. The magnets 515 also may serve to laterally and vertically secure cage 100.

As further shown in FIG. 22, animal housing 5 may also comprise a grate 520. Grate 520 comprises any suitable grate-like shape and configuration. Without limitation, grate 520 comprises openings of a sufficient diameter to allow animal waste to fall through grate 520. In another embodiment, a pan (not illustrated) is disposed beneath grate 520. The pan may be comprised of any suitable material. Without being limited by theory, animal waste that falls through grate 520 is captured by the pan. Grate 520 and the pan are slidably insertable into base 500. Grate 520 and the pan may be inserted and removed from base 500 in the directions as illustrated by arrow 525. In an embodiment (not illustrated), grate 520 and the pan are inserted into base 500 through an opening in base 500. In some embodiments, a thermoelectric cushion may be disposed on the gate.

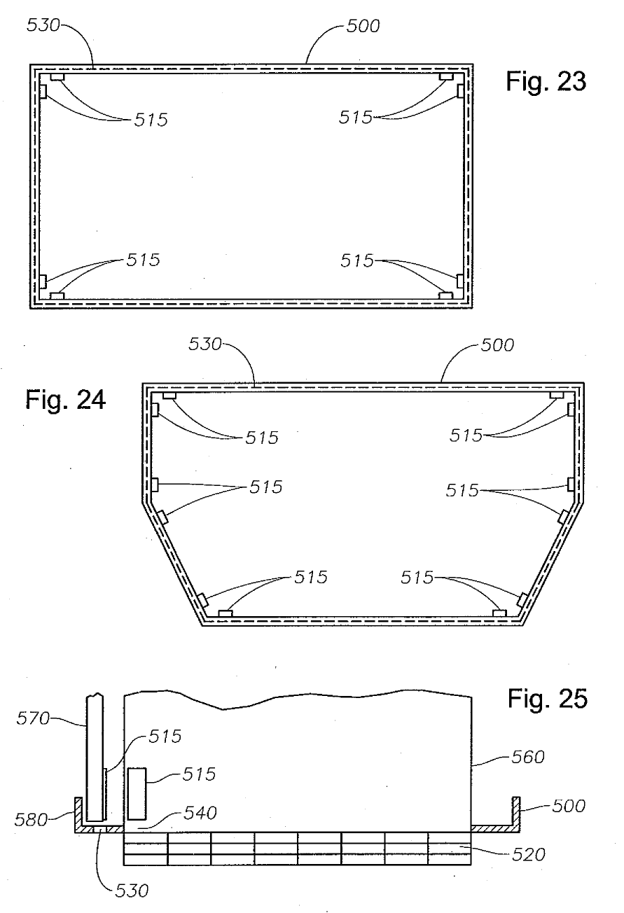

FIG. 23 illustrates a top view of an embodiment of base 500. In such an embodiment, base 500 comprises a plurality of drain holes 530. Without being limited by theory, drain holes 530 allow fluid such as water to pass into the pan. FIG. 24 illustrates an embodiment of base 500 having a different configuration than that shown in FIG. 23.

FIG. 25 illustrates a cross sectional side view of an embodiment of base 500 having a lip 580. In such an embodiment, lip 580 provides a cavity 540 in which grate 520 may be inserted. For instance, lip 580 comprises a raised portion of base 500. The walls 570 and corners 560 of base 500 are disposed upon lip 580, which provides cavity 540 for insertion of grate 520. In such an embodiment, the pan is disposed beneath grate 520, which provides spacing in cavity 540 between the grate 520 and the pan. Lip 580 may also comprise one or more drain holes 530. As further illustrated, magnets 515 may disposed on corner 560 and wall 570.

In an embodiment (not illustrated), animal housing 5 comprises an air purifier. In alternative embodiments, animal housing 5 comprises more than one air purifier. Any air purifier suitable for use in removing contaminants from the air within animal housing 5 may be used. Without limitation, examples of suitable air purifiers include mechanical filter devices, absorbent devices (e.g., devices that filter air through absorbents such as charcoal), and air ionizers. Any air ionizer suitable for removing particulate from air in animal housing 5 may be used. An example of an air ionizer is an electrostatic precipitator. Electrostatic precipitators refer to a particulate collection device that removes particles from air using the force of an induced electrostatic charge. Without limitation, examples of commercial electrostatic precipitators include the NATURAL AIR and HYBRID GP. The NATURAL AIR is an electrostatic precipitator commercially available from Natural Air Systems, Inc. HYBRID GP is an electrostatic precipitator commercially available from THE SHARPER IMAGE. The air purifier may be disposed at any suitable location on animal housing 5 by which the air purifier may remove particulate from the air within animal housing 5. For instance, one or more air purifiers may be disposed on the inside of a side of animal housing 5.

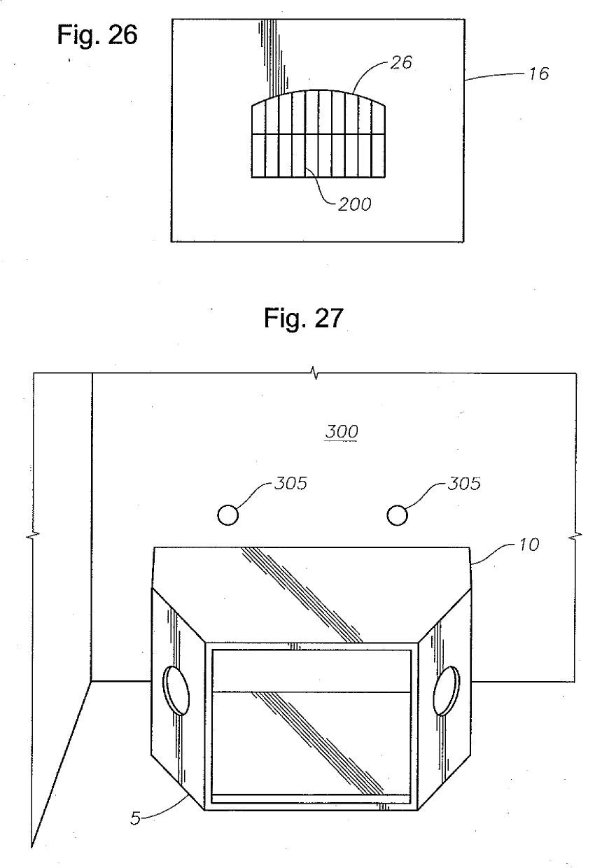

In an embodiment, animal housing 5 has a grate disposed in at least one opening. In such an embodiment, animal housing 5 may or may not have a cage 100, preferably animal housing 5 does not have cage 100 in such embodiments. Such grates may be secured to animal housing 5 by any suitable means. In some embodiments, all openings of animal housing 5 include a grate. The grate may extend across all or a portion of an opening, preferably all of an opening. FIG. 26 illustrates an embodiment in which side 16 has grate 200 in opening 26.

In some embodiments (not illustrated), an air purifier is attached to a grate or cage 100 in an opening of animal housing 5. The air purifier may be attached to a grate or cage 100 by any suitable means. In an embodiment, the air purifier is attached to a grate or cage 100 by hooks. For instance, hooks are attached to a side of the air purifier. In an embodiment, the air purifier has one or more than one hook, alternatively the air purifier has two hooks. The hooks may be of any size suitable for attaching the air purifier. The hooks may be attached to the air purifier by any suitable means such as by injection molding, welds, glue, screws, and the like. In an embodiment, the air purifier is movably attached to a grate or cage 100. For instance, the air purifier may swivel in a vertical direction in relation to a grate or cage 100. In some embodiments, one or more magnets may also be attached to the air purifier. In an embodiment, one or more magnets are attached to the same side of the air purifier as the hooks. Any magnet suitable for securing the air purifier to a grate or cage 100 may be used. In some embodiments, the magnet is a permanent magnet. In an embodiment, the air purifier is attached to a grate or cage 100 by one or more hooks. In such an embodiment, the air purifier then may swivel down until at least one magnet is in magnetic attraction to the grate or cage 100 thereby securing the air purifier. It is to be understood that the grate and cage 100 in such embodiments is composed of a magnetically attractive material (e.g., a magnet, iron, steel, and the like). In an embodiment in which animal housing 5 includes an outer covering of a weaving, the air purifier may be attached to the weaving. For instance, the weaving may be pliable, and the hooks may slide down between gaps in the weaving to thereby secure the air purifier to the outer covering. In an embodiment in which animal housing 5 has plastic sides, the air purifier may be secured to animal housing 5 by each hook sliding into an opening in a side of animal housing 5.

Although the present invention and its advantages have been described in detail, it should be understood that various changes, substitutions and alterations may be made herein without departing from the spirit and scope of the invention as defined by the appended claims.

What is claimed is:

1. An animal housing, comprising:
a top;
a plurality of sides, wherein the plurality of sides provide support to the top; and
a bedding, wherein the bedding comprises a cushion, a pillow, a magnet, and a magnetically attractive material, wherein magnetism of the magnet attracting the magnet to the magnetically attractive material secures the pillow to the cushion.

2. The animal housing of claim 1, wherein the magnet is secured to the pillow.

3. The animal housing of claim 2, wherein the cushion is disposed within a cover, and wherein the magnetically attractive material is in magnetic contact with the magnet through the cover.

4. The animal housing of claim 1, wherein the magnetically attractive material is secured to the pillow.

5. The animal housing of claim 4, wherein the cushion in disposed within a cover, and wherein the magnet is in magnetic contact with the magnetically attractive material through the cover.

6. The animal housing of claim 1, wherein an air purifier is secured to the animal housing.

7. The animal housing of claim 6, wherein the air purifier comprises a hook, and wherein the air purifier is attached to the animal housing by the hook.

8. The animal housing of claim 7, wherein the air purifier further comprises a magnet, and wherein the magnet secures the air purifier to the animal housing by magnetism.

9. A method for providing bedding for an animal housing, comprising:
(A) providing an animal housing, wherein the animal housing comprises a top and a plurality of sides, and wherein the plurality of sides provide support to the top;
(B) providing a cushion and a pillow;
(C) securing the pillow to the cushion by magnetic attraction to provide the bedding; and
(D) disposing the bedding on the top or inside the animal housing.

10. The method of claim 9, wherein a magnet is secured to the pillow, and wherein the cushion is disposed within a cover, and further wherein step (C) further comprises disposing a magnetically attractive material inside the cover and moving the magnetically attractive material to a position at which the magnet is secured to the magnetically attractive material by magnetism.

11. The method of claim 9, wherein a magnetically attractive material is secured to the pillow, and wherein the cushion is disposed within a cover, and further wherein step (C) further comprises disposing a magnet inside the cover and moving the magnet to a position at which the magnet is secured to the magnetically attractive material by magnetism.

12. The method of claim 9, wherein a magnet is secured to the cushion, and wherein the pillow is disposed within a pillow cover, and further wherein step (C) further comprises disposing a magnetically attractive material inside the pillow cover and moving the magnetically attractive material to a position at which the magnet is secured to the magnetically attractive material by magnetism.

13. The method of claim 9, wherein a magnetically attractive material is secured to the cushion, and wherein the pillow is disposed within a pillow cover, and further wherein step (C) further comprises disposing a magnet inside the pillow cover and moving the magnet to a position at which the magnet is secured to the magnetically attractive material by magnetism.

14. The method of claim 9, wherein a magnetically attractive material is secured to the pillow and a magnet is secured to the cushion, and wherein step (C) further comprises disposing the pillow on the cushion in a position at which the magnet is secured to the magnetically attractive material by magnetism.

15. The method of claim 9, wherein a magnetically attractive material is secured to the cushion and a magnet is secured to the pillow, and wherein step (C) further comprises disposing the pillow on the cushion in a position at which the magnet is secured to the magnetically attractive material by magnetism.

16. The method of claim 9, further comprising:
(E) attaching an air purifier to the animal housing.

17. The method of claim 16, wherein attaching the air purifier is accomplished by a hook.

18. The method of claim 17, wherein the hook is secured to the air purifier.

19. The method of claim 17, wherein the air purifier comprises a magnet, and wherein step (E) futher comprises securing the air purifier to the animal housing by magnetism.

20. The method of claim 9, further comprising:
(E) securing the pillow or a second pillow to an object.
